(19) United States
(12) Patent Application Publication
(10) Pub. No.: US 2003/0034146 A1
(43) Pub. Date: Feb. 20, 2003

(54) System and method for detecting flaws in plate-type heat exchanger

(76) Inventor: Israel Kaufman, Ein-Harod Meuhad (IL)

Correspondence Address: Edward Langer, c/o Landon & Stark Associates, One Crystal Park, Suite 210, 2011 Crystal Drive, Arlington, VA, 22202-3709, US

(21) Appl. No.: 10/200,116

(22) Filed: Jul. 23, 2002

(30) Foreign Application Priority Data
Aug. 16, 2001 (IL) 144962

(51) Int. Cl. G05D 15/00; G05D 16/00; G05D 23/00

(52) U.S. Cl. 165/11.1; 165/281

(57) ABSTRACT

A system for detecting flaws in assembled plate type heat exchangers with minimum stoppage of the production line. The system comprises a high pressure air path and a low pressure water path, flowing in opposite directions, and a sensor for detecting pressure increases in the low pressure path. Such pressure increases occur as a result of flaws in the plate, permitting pressure transfer from the high pressure path. The pressure sensor is connected to a valve which opens in response to increased pressure level in the low pressure path. A pulse counter counts the number of times the valve opens and provides a readout to a convertor. The size of holes present may be determined by computerized conversion of the counter readings and may be provided as a printout.

### FIELD OF THE INVENTION

The present invention relates to detection of leaks through flaws in plate type heat exchangers.

### BACKGROUND OF THE INVENTION

Pasteurization involves inactivation of spoilage organisms in milk, fruit juices and other liquid food products by applying heat at temperatures below the boiling point of the liquid for a specified period of time, without allowing recontamination of the liquid during the heat treatment process.

Pasteurization is carried out in order to make liquids safe for human consumption by destroying all bacteria that may be harmful to health. Pasteurization also increases the shelf life of liquids by destroying some undesirable enzymes.

To ensure destruction of all pathogenic microorganisms, time and temperature combinations of the pasteurization process are highly regulated.

There are two basic methods of pasteurization, batch and continuous. The batch method uses a vat pasteurizer which consists of a jacked vat surrounded by either circulating water, steam or heating coils of steam or water.

The continuous method has several advantages over the vat method, the most important being time and energy saving. For most continuous processing, a high temperature short time pasteurizer is used. The heat treatment is accomplished using a plate heat exchanger. This consists of a stack of metal plates clamped together in a frame. The plates must be thin and conductive in order for heat exchange to occur, yet strong enough to withstand any pressure by the fluid. Corrugated stainless steel plates are most commonly used. The heating medium can be vacuum steam or hot water.

Heating and cooling energy can be saved using a heat exchanger, which utilizes the heat of the pasteurized product to warm the incoming cold product. Cold raw milk, or other liquid, at 4 C. in a constant level tank is drawn into the heat exchanger section of the pasteurizer. Here it is warmed to approximately 60 C. by heat given up by hot pasteurized milk flowing in a counter current direction on the opposite side of thin stainless steel plates.

The raw milk, still under suction, passes through a positive displacement timing pump which delivers it under positive pressure through the rest of the pasteruization system.

The raw milk is forced through the heater section where hot water on opposite sides of the plates heats milk to a temperature of at least 70 C. The milk, at pasteurization temperature and under pressure, flows through a holding tube where it is held for a specified time period. Heated milk then flows to the pasteurized milk heat exchanger section where it gives up heat to the raw product and is itself cooled.

The cooled milk then passes through the cooling section, where it is further cooled to 4 C. or below by coolant on the opposite sides of the stainless steel plates, prior to packaging.

It is extremely important that frequent checks for holes which may develop in the plates of the heat exchanger are carried out, in order to avoid contamination of pasteurized product with raw product.

The cost of finding and repairing the leak can be very high, especially as most techniques include shutting down of the production line, dismantling of the pasteurizer and time-consuming testing of the individual heat exchange plates. In addition, readings obtained in known methods are frequently affected by extraneous factors, rendering the results unreliable.

A method currently in use for testing for leaks in a heat exchanger having a path B for product and a separate path A for coolant is described in U.S. Pat. No. 6,062,068 to Bowling. This method involves circulating a donor fluid under pressure in path A whilst a recipient fluid such as clean tap water is circulated in path B. If the donor fluid is an electrolyte, a probe is placed in path B to measure the conductivity of the recipient fluid. A rise in conductivity over a period indicates leakage between the two paths, the rate of change indicating the size of the leak.

The method described by Bowling is time-consuming and results obtained are subject to inaccuracies caused by various factors.

Therefore it would be desirable to provide an efficient and reliable method of checking for leaks in heat exchangers, which is fast, accurate and does not require stoppage of the production line or disassembly of the heat exchanger.

### SUMMARY OF THE INVENTION

Accordingly, it is an object of the present invention to overcome the disadvantages of the prior art and provide a method of checking heat exchangers for leaks, which is fast, reliable, accurate and which can be carried out on an assembled system with minimum stoppage of production, resulting in lower cost.

In accordance with a preferred embodiment of the present invention, there is provided a system for detecting leakage in a heat exchanger, having a series of heat exchange plates, wherein leakage may occur between physically separate first and second fluid paths arranged in an intimate heat exchange relationship via the series of heat exchange plates, said system comprising a high pressure fluid path; a low pressure fluid path; and a sensor for detecting pressure changes in said low pressure path, wherein an increase in pressure in said low pressure fluid path as a result of pressure transfer from said high pressure fluid path indicates a leak in said heat exchange plates separating said high and low pressure fluid paths.

According to a preferred embodiment, there is provided a system for detecting holes or cracks in the heat exchange plates of a heat exchanger, which results in leakage between fluid paths on either side of the damaged plate. The system comprises two fluid paths, flowing in opposite directions, one of high pressure and the other of low pressure, and a sensor for detecting any increase in the pressure of the low pressure path. Such pressure increases occur as a result of pressure transfer from the high to the low pressure path via holes or cracks in the plate separating the two paths and therefore indicate the presence of flaws in the plate.

A feature of the present invention is that the system provides highly accurate and reliable results.

An advantage of the present invention is that testing can be carried out on an assembled heat exchanger.

A further advantage of the present invention is the test is rapid.

A further advantage of the present invention is that the test results are not affected by extraneous factors.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding sections or elements throughout, and in which:

FIG. 1 is a schematic representation of a prior art leakage testing method; and

FIG. 2 is a schematic representation of the flaw detection system of the present invention.

### DETAILED DESCRIPTION OF THE PREFERRED EMBODIMENTS.

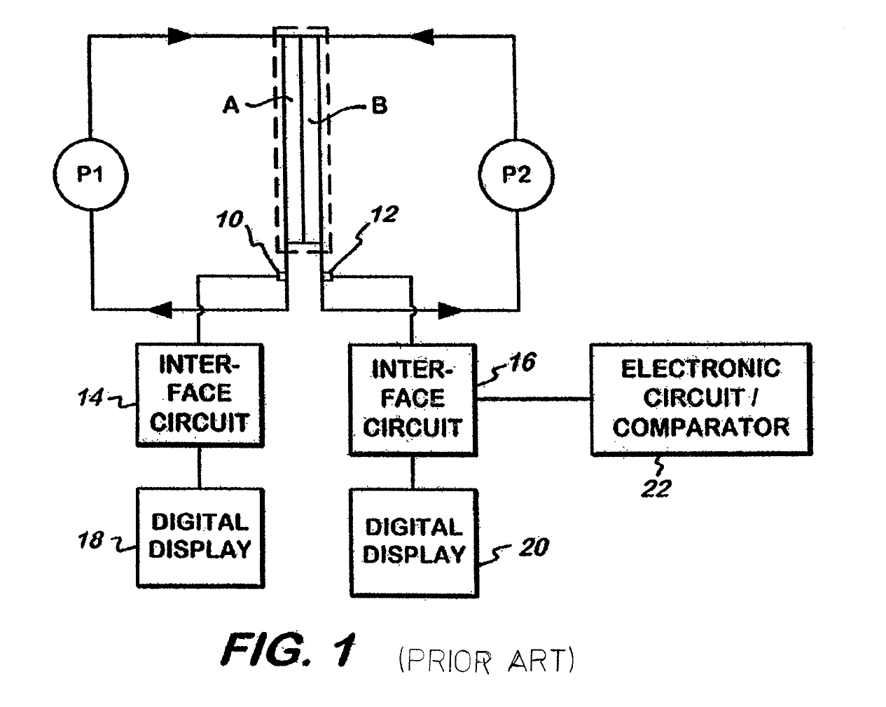

For a better understanding of the subject matter, the prior art system described by Bowling for detecting leaks in heat exchanger plates of a pasteurizer is shown in FIG. 1. The pasteurizer is outlined by dashed lines. The heat exchanger has a first path A for coolant and a second path B for the milk product.

The pasteurizer is tested for leaks between paths A and B by circulating an electrolytic donor fluid through path A in a closed loop by means of a circulation pump P1, while a recipient fluid such as clean tap water is circulated in a closed loop through path B using a pump P2.

Contacting type conductivity probes 10 and 12 of known construction are placed in the donor fluid and recipient fluid paths A and B respectively. Each probe is connected via a suitable electronic interface circuit 14, 16, to a digital display 18, 20 respectively, which gives a conductivity readout in suitable units.

If no increase in conductivity in path B occurs, no leak is present. A steady increase in the conductivity of the water circulating in the recipient fluid path B indicates that electrolyte has leaked from the donor fluid into the recipient fluid.

The method described by Bowling has a number of disadvantages:

1. In the case of large heat exchangers, involving liquid containers of around 400 liters, which are commonly used in industry, the test is extremely time consuming, requiring approximately 1.5 hours per circuit. Since most heat exchangers consist of a number of circuits, the production line must be stopped for a considerable time.

2. The method measures changes in electrical conductivity, which can be affected by a number of factors, such as water temperature or detergent residue remaining in the heat exchanger after cleaning.

3. The method requires a water supply of between 20,000 to 50,000 liter/hour, which is supplied by a small pump of capacity 3,000 liter/hour. This results in a number of areas in the heat exchanger not being reached by the circulating water, and therefore not being tested. A pump of adequate size for supplying the necessary water quantities to make the test reliable would be too large for practical purposes.

Bowling also describes use of a gas as a donor fluid and detection of leakage using an ultrasound probe. In this method, the reading is affected by various background factors, such as air bubbles between plates, which render the test inefficient and unreliable.

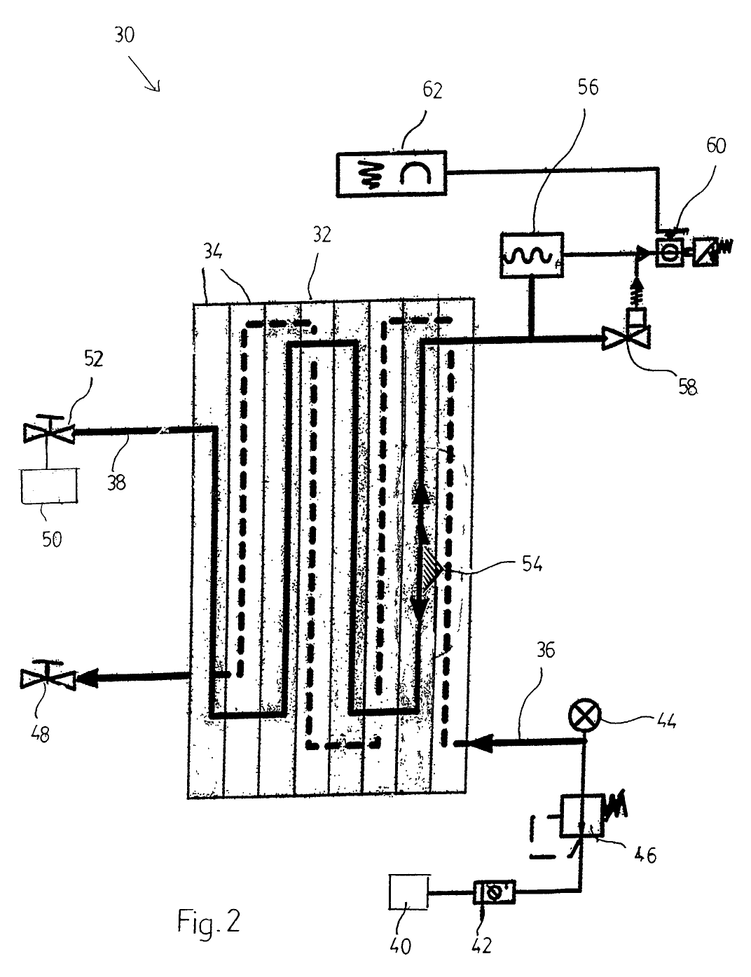

Referring now to FIG. 2, the system 30 of the present invention is shown. Heat exchanger 32 comprises a plurality of thin conductive plates 34, preferably of corrugated stainless steel. In order to test for holes or cracks in plates 34, two circuits are established, high pressure circuit 36 and low pressure circuit 38. If a hole or crack exists in plates 34, pressure from circuit 36 will be transferred via the hole to low pressure circuit 38, causing an increase in pressure of circuit 38.

High pressure circuit 36 is connected at one end to an air source 40 controlled by valve 42. Air at pressure of up to 4 Atm is passed into circuit 36, pressure being monitored by manometer 44 and precisely adjusted by regulator 46. Air is prevented from exiting circuit 36 during the leakage detecting procedure by valve 48, which remains closed throughout the procedure. Upon conclusion of the procedure, valve 48 is opened to allow air to exit circuit 36.

Low pressure circuit 38 is connected at one end to a water source 50 providing water at atmospheric pressure, controlled by valve 52. Water in circuit 38 circulates through heat exchanger 32. Alternatively, circuit 38 may contain air or a mixture of air and water at atmospheric pressure.

If a hole 54 exists in one of the plates 34 of heat exchanger 32, air passes from high pressure circuit 36 to low pressure circuit 38.

At the end of circuit 38 is an extremely sensitive pressure sensor 56, which is capable of detecting pressures of 0.2 mbar. An electric valve 58 is connected to sensor 56 and is opened upon pressure level rising above 0.2 mBar to restore pressure to atmospheric level, then close. A pulse counter 60 counts the number of times valve 58 is opened within a set time period and provides a readout to convertor 62.

The size of holes 54 present can be determined by computerized conversion of the readings from counter 60, and may be provided as a printout.

The response of the system is extremely fast, requiring approximately 15 minutes per cycle. Since the system described by Bowling requires approximately 1.5 hours per cycle, the system of the present invention provides an 83.33% saving in time over the prior art.

Having described the invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A system for detecting leakage in a heat exchanger, having a series of heat exchange plates, wherein leakage may occur between physically separate first and second fluid paths arranged in an intimate heat exchange relationship via the series of heat exchange plates, said system comprising:
a high pressure air path;
a low pressure fluid path; and
a sensor for detecting pressure changes in said low pressure fluid path,
wherein an increase in pressure in said low pressure fluid path detected by said sensor as a result of pressure transfer from said high pressure air path indicates a leak in said heat exchange plates separating said high pressure air path and low pressure fluid path.

2. The system of claim 1 wherein the pressure in said low pressure fluid path is atmospheric pressure.

3. The system of claim 1 wherein the pressure in said high pressure air path is less than 4 Atm.

4. The system of claim 1 wherein air entering said high pressure path is controlled by an inlet valve.

5. The system of claim 4 wherein said pressure in said high pressure path is monitored by a manometer.

6. The system of claim 5 wherein said inlet valve is controlled by a regulator device in response to pressure changes registered by said manometer.

7. The system of claim 1 wherein air may be released from said high pressure path via a release valve.

8. The system of claim 1 wherein said low pressure fluid path contains water.

9. The system of claim 1 wherein said low pressure fluid path contains air.

10. The system of claim 1 wherein said low pressure fluid path contains air in water.

11. The system of claim 1 wherein fluid entering said low pressure fluid path is controlled by an inlet valve.

12. The system of claim 1 wherein said pressure sensor is connected to an electrically-controlled valve which opens in response to detection of said pressure changes by said sensor and closes upon return of return of pressure in said low pressure path to its original level.

13. The system of claim 11 wherein said electrically-controlled valve opens in response to pressure changes of above 0.2 mBar.

14. The system of claim 11 further comprising a timer for measuring time intervals and a pulse counter for counting each time said electric valve opens in response to said pressure changes detected by said sensor during said time intervals.

15. The system of claim 13 further comprising a convertor to provide a readout from said pulse counter and said timer, indicating a total of said electric valve openings per time interval.

16. A method for detecting leakage in a heat exchanger, having a series of heat exchange plates, wherein leakage may occur between physically separate first and second fluid paths arranged in an intimate heat exchange relationship via the series of heat exchange plates, said method comprising the steps of:
providing a high pressure air path, a low pressure fluid path and a sensor for detecting pressure changes in said low pressure path; and
monitoring said pressure increases in said low pressure path as an indication of leakage in said heat exchange plates separating said high and low pressure fluid paths.
